(19) United States
(12) Patent Application Publication
(10) Pub. No.: US 2026/0049956 A1
(43) Pub. Date: Feb. 19, 2026

(54) SENSOR ARRANGEMENT FOR SENSING A FILLING STATE OF AN ABSORBENT ARTICLE

(71) Applicant: Essity Hygiene and Health Aktiebolag, Goteborg (SE)

(72) Inventor: Henrik Pettersson-Falk, Göteborg (SE)

(21) Appl. No.: 19/102,930

(22) PCT Filed: Sep. 6, 2022
(86) PCT No.: PCT/EP2022/074733

§ 371 Date: Feb. 11, 2025

(51) Int. Cl. G01N 27/22

(52) U.S. Cl. CPC G01N 27/225; G01N 27/226; G01N 27/228

(57) ABSTRACT

A sensor arrangement for sensing a filling state of an absorbent article with a liquid absorbent layer, the sensor arrangement comprising a substrate, a plurality of planar capacitors, each one comprising a set of at least two corresponding capacitor electrodes being arranged next to each other on or in the substrate, and a plurality of conductor paths on or in the substrate connecting the capacitor electrodes toward terminals of a readout circuit, wherein at least two of said planar capacitors are connected in parallel.

### CROSS REFERENCE TO RELATED APPLICATIONS

This application is a National Stage Application of PCT/EP2022/074733, filed Sep. 6, 2022, the contents of which are incorporated by reference in their entirety herein.

### TECHNICAL FIELD

The present invention relates to a sensor arrangement for sensing a filling state of an absorbent article. The present invention in particular relates to improving the aspects of identifying voiding events during which bodily fluids are released toward a liquid absorbent layer of an absorbent article. The present invention further relates to absorbent articles such as a diaper.

### BACKGROUND

Absorbent articles are used for addressing conditions such as leakage issues or incontinence. Such absorbent articles, mostly in the form of diapers, are likewise used for individuals but applied and managed by nursing personnel in the context of nursing homes, hospitals and home care environments. In each such environment, the filling state and the need for replacement of a full absorbent article are of considerable interest, as well as the assessment of an individual's specific voiding behavior. Especially the latter is an important input regarding the possibility of forecasting the use of absorbent articles, the planning of replacement schedules and the managing of sufficient supply in both individual environments as well as in larger contexts of the aforementioned nursing homes and the like.

There are techniques to detect the filling state of absorbent articles, such as diapers, that, amongst others, consider the use of conducting wires integrated into a diaper's liquid absorbent layer. As the sensor arrangement is integrated and hard-wired with the absorbent article, it needs to be disposed of once the absorbent article is full or needs replacement. At the same time, the measurement of voiding behavior and related figures, such as voiding volume and timings, is usually of interest for prolonged time spans. An initial assessment regarding a likely voiding pattern requires at least several days or weeks of monitoring, while the long-term application in nursing homes under a replacement alert regime requires sensors on an everyday basis.

There is the desire to decouple the sensor arrangement from the absorbent article as such, so that the former can be reused several times, while the latter can be disposed of whenever required at keeping the involved cost low. However, the application of external sensor arrangements suffers from reliability issues as close or direct contact solutions are not feasible, but other alternatives provide only little sensitivity and/or reliability while being prone to external conditions, such as a patient's movement and the direct close environment of the bed or patient station.

There is therefore a need for improved sensor arrangements to be used in the context of absorbent articles, that provide ease as well as reliability of operation. Likewise, there is a need for an accordingly improved absorbent article, such as a diaper.

### SUMMARY

The mentioned problems and drawbacks are addressed by the subject matter of the independent claims. Further preferred embodiments are defined in the dependent claims. Specifically, the embodiments of the present invention may provide substantial benefits that are described in part herein.

According to one aspect of the present invention there is provided a sensor arrangement for sensing a filling state of an absorbent article with a liquid absorbent layer, the sensor arrangement including a substrate, a plurality of planar capacitors, each one including a set of at least two corresponding capacitor electrodes being arranged next to each other on or in the substrate, and a plurality of conductor paths on or in the substrate connecting the capacitor electrodes toward terminals of a readout circuit, wherein at least two of said planar capacitors are connected in parallel.

According to another aspect of the present invention there is provided an absorbent article including a sensor arrangement for sensing a filling state of the absorbent article with a liquid absorbent layer, the sensor arrangement including a substrate, a plurality of planar capacitors, each one including a set of at least two corresponding capacitor electrodes being arranged next to each other on or in the substrate, and a plurality of conductor paths on or in the substrate connecting the capacitor electrodes toward terminals of a readout circuit, wherein at least two of said planar capacitors are connected in parallel.

### BRIEF DESCRIPTION OF THE DRAWINGS

Embodiments of the present invention, which are presented for better understanding the inventive concepts but which are not to be seen as limiting the invention, will now be described with reference to the figures in which:

FIG. 1 shows a schematic view of a sensor arrangement for sensing a filling state of an absorbent article according to an embodiment of the present invention;

FIGS. 2A and 2B show schematic views of a sensor arrangement in a strip-like configura-tion according to an embodiment of the present invention;

FIG. 3 shows a schematic view of an impedance behavior of a sensor arrangement according to an embodiment of the present invention;

FIGS. 4A to 4C show schematic views of parallel connections of capacitors in a sensor arrangement according to corresponding embodiments of the present invention;

FIGS. 5A to 5C show schematic views of electrode layouts of capacitors in a sensor arrangement according to corresponding embodiments of the present invention; and

FIGS. 6A to 6C show schematic views of electrode and capacitor configurations in strip-like sensor arrangements according to corresponding embodiments of the present invention.

### DETAILED DESCRIPTION

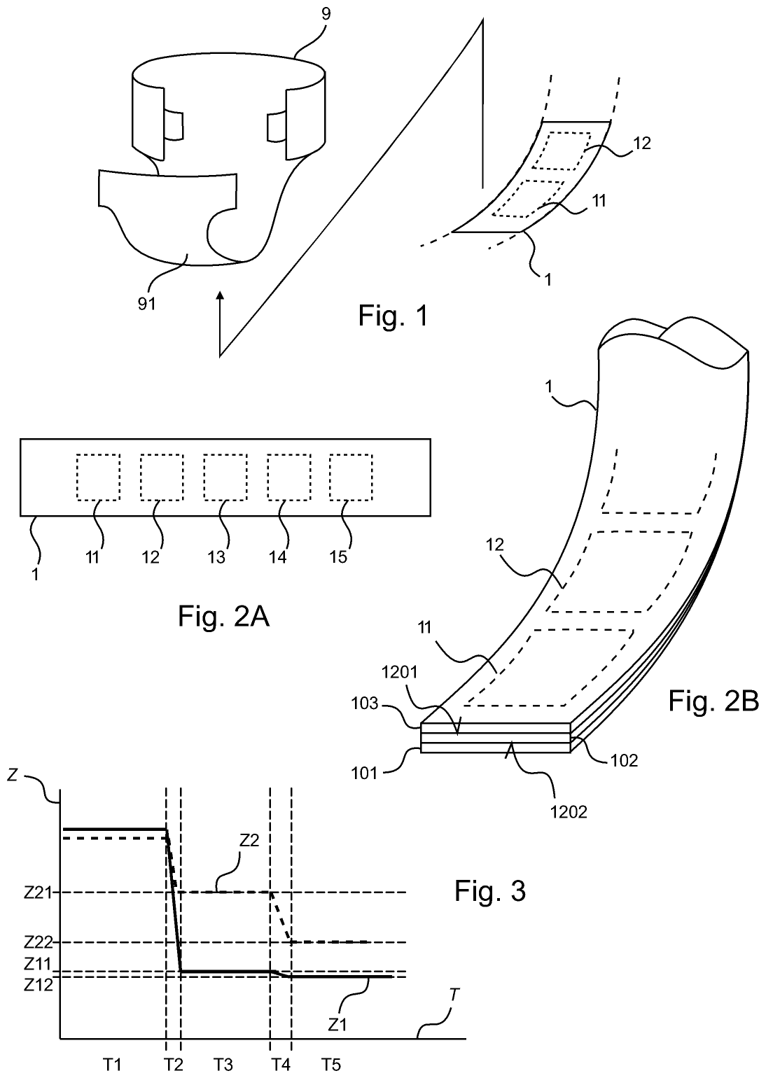

FIG. 1 shows a schematic view of a sensor arrangement for sensing a filling state of an absorbent article according to an embodiment of the present invention. Specifically, the absorbent article includes a liquid absorbent layer as, for example the shown diaper 9. Generally, however, the absorbent article can be any one of diapers for children, diapers for adults, pads, protectors and the like. The liquid absorbent layer is a layer that includes or consists of an absorbent material that is able to absorb a liquid in the specific context of bodily fluids including urine, blood, faces, and the like. The absorbent material may be arranged to absorb such a liquid up to a given capacity and to retain the liquid a given time. Further, the absorbent material may be arranged to convey liquid to a neighboring area so that absorbent material in the vicinity can absorb the liquid that is not absorbed by absorbent material upstream toward the liquid source.

A sensor arrangement 1 is provided for use with such an absorbent article and may be arranged for that purpose to be, for example, attachable to an outside surface 91 of the exemplary diaper 9. The sensor arrangement 1 may assume the form of a strip and generally includes a substrate and a plurality of planar capacitors 11, 12, each one including a set of at least two corresponding capacitor electrodes being arranged next to each other on or in the substrate. The capacitor electrodes are arranged next to each other in the sense that they are not facing each other with their main surface. In other words, the larger surfaces of the electrodes are not facing each other and may be arranged in one, potentially flexible, plane of the sensor arrangement and/or the substrate, while the far smaller side surfaces of the conducting material forming the capacitors may be oriented facing each other.

As the capacitors are located in the vicinity of the liquid absorbent layer, at least in the state when the sensor arrangement is attached to the absorbent article, the liquid absorbed interacts with the capacitor so as to change the effective measurable capacitance. The sensor arrangement 1 is in this way arranged for sensing a filling state of the absorbent article which may include the use for detecting voiding events as such, assess the absorbed volume, determine a degree of saturation potentially in relation with a maximum or a target absorption capacity. In this way, potential applications of the embodiments of the present invention may include any one of voiding behavior assessment, voiding monitoring, capacity monitoring, monitoring the need for changing the absorbent article and the like. In order to access the capacitors 11, 12, the absorbent article 1 further includes a plurality of conductor paths on or in the substrate connecting the capacitor electrodes toward terminals of a readout circuit.

According to the embodiments of the present invention, at least two of said planar capacitors are connected in parallel. One may refer to as a so-called pair of capacitors if the respective two capacitors forming that pair are connected in series. Generally, however, the embodiments of the present invention assume the understanding of a pair in the sense of a set that includes at least two of parallel connected planar capacitors, wherein the set can well also include three or more parallel connected planar capacitors.

FIGS. 2A and 2B show schematic views of a sensor arrangement in a strip-like configuration according to an embodiment of the present invention. Specifically, the sensor arrangement for sensing a filling state of an absorbent article 1 is shown as including a substrate 102 with the plurality of planar capacitors 11, 12, . . . . The capacitors are spaced apart and arranged in the longitudinal direction, or longer extension, of the strip-like sensor arrangement 1. Specifically, in this embodiment, the substrate assumes an elongated strip-like shape with a longitudinal direction along the elongation, and wherein the planar capacitors are arranged along said longitudinal direction. The term “elongated” is to be understood that the length of the strip-like sensor arrangement is longer in the longitudinal direction as compared to the width in the transversal direction. Usually, the ratio length/width is more than 3. Further, the sensor arrangement's longitudinal direction is preferably intended to align with the longitudinal (front/back) extension of the absorbent article, or at least the extension of the liquid absorbent layer therein. Typical lengths may thus be in the range of 150 mm to 1000 mm, 200 mm to 800 mm, 300 mm to 700 mm, for example 490 mm, 500 mm, 690 mm, or 700 mm. Generally, the sensor arrangement length should be adapted to the length of the absorbent core of the absorbent article or, in other words, the region of interest. Typical widths are in the range of 10 to 40 or 15 to 30, for example about 25 mm.

Generally, the substrate can be flexible and be configured as a flexible printed circuit board (PCB) with the corresponding, and known as such, base materials and having conductive paths and areas formed from, for example, a copper or metal layer by etching or other types of applicably lithography techniques. As an alternative to etching, any conductive paths and areas may also be formed by printing, inkjet printing, silkscreen printing and the like.

The substrate 102 in this way includes a first surface 1201 and second surface 1202, wherein the capacitor electrodes are arranged on together on one of said first and second surface. Preferably, the capacitor electrodes are arranged together on one the first surface 1201 which would be the one surface that is closer to the liquid absorbent layer of the absorbent article in a state when attached to the latter. In this way, the distance between the capacitor electrodes and the liquid absorbent layer, any liquid absorbed therein being the subject of the measurement, can be minimized and sensitivity of the sensor arrangement as a whole can be optimized.

In general, the sensor arrangement according to the embodiments of the present invention may be arranged to accompany the liquid absorbent layer of the absorbent article. For this purpose, the sensor arrangement 1 may include an adhesive layer 103 facing toward the absorbent article (e.g. diaper 9). For example, the adhesive layer 103 may be formed of or include an adhesive or part of a hook-and-loop fastener that is able to affix sufficiently well the sensor arrangement to the absorbent article. In general, however, other ways of fixation or accompany are considered, including, for example, that the sensor arrangement can be incorporated in an outer pant, or positioned in some kind of pocket inside of or on the outer side of the absorbent article.

In case of employing an adhesive layer though, the material and/or components of the adhesive layer 103 may be adapted to the particular properties of the surface 91 of the absorbent article 9. For example, an absorbent article in the exemplary form of diaper 9 may feature a textile or textile-like surface 91 to which a hook-part of a hook-and-loop fastener may well adhere. Such an adhesive layer may further provide the benefit of being detachable from the absorbent article once the latter need to be replaced. The sensor arrangement can then be easily reused by attaching it to a new absorbent article (e.g. diaper) without compromising the integrity of the used absorbed article, i.e. not destroying or damaging the surface 91 when attaching, being attached and/or detaching. Therefore, while the sensor arrangement may be arranged to adhere on an outer surface of the absorbent article it is likewise well adapted to sense the filling state of the absorbent article while galvanically isolated from the liquid absorbent layer.

The absorbent article may generally include further components, seals, and/or layers. As also shown in FIG. 2B, the sensor arrangement 1 includes an outer layer 101 which may include or consist of a sealant, such as rubber, lacquer, silicone, thermoplastic and the like. Likewise, the whole sensor arrangement, i.e. the substrate strip of the present embodiment may be fully silicone embedded. Given the context of sensing a filling state of an absorbent article, in turn in the specific context of absorbing bodily fluids, sealing and/or protection from humid environment may be desirable. Further, as the sensor arrangement may be used several times, it may well also be desirable to have the arrangement cleaned for hygiene purposes, which may involve, for example, treatment with detergents and/or disinfectants, heat treatment, radiation treatment and the like. As a further additional layer an earth plane may be provided that protects the electric measurement circuitry from electromagnetic interference (EMI) form the outside. For example, such an earth plane may be implemented by a mesh-like pattern of a conductive material on the second surface 1202 of the substrate 102.

FIG. 3 shows a schematic view of an impedance behavior of a sensor arrangement according to an embodiment of the present invention. As explained, the embodiments of the present invention provide for a sensor arrangement for sensing a filling state of an absorbent article with a plurality of planar capacitors wherein at least two of these planar capacitors are connected in parallel. Specifically, the embodiments of the present invention consider the sensing of a filling state of a liquid absorbent layer by means of interaction of absorbed liquid with the effective dielectric properties of a capacitor. Further, it is considered the usual behavior of emission of bodily fluids in that emission—and corresponding absorption—is less a continuous process but more a process that happens in events. Namely, bodily fluids are released in so-called voiding events during which a specific volume of bodily fluid is emitted during a relatively short time span, whereas no or little fluid is released during intermittent and relatively longtime spans (voiding pauses).

Under the assumption that a single planar capacitor is arranged alongside a liquid absorbent layer, the liquid absorbed will change the dielectric properties of the capacitor. The effective capacitance C is generally determining the impedance of the capacitor circuit, wherein the impedance is the opposition to alternating current presented by the combined effect of resistance and reactance in a circuit.

Specifically, one may apply an AC voltage source to the capacitors electrodes and measure the strength of the AC signal that is reflected by the capacitor in the sense of an AC resistor. This technique is as such known and usually referred to as network analysis (e.g. a corresponding so-called network analyzer is a readout circuit that applies an AC signal to an AC-impedance, e.g. a capacitor, and measures the reflected AC power for determining the impedance value). The readout circuit may thus generally include an RF/AC (radio frequency, alternating current) source, directional couplers, an impedance measurement test set, a so-called “S-parameter” test set or parts thereof, that generally consider an impedance change of the full circuit, including the connector, the conductor paths in the sense of impedance matched or well-defined impedance strip lines, due to the capacitance change predominantly appearing in the capacitors as a result of liquid absorption in an immediate vicinity of the capacitor electrodes.

In the above assumption, the capacitance, and with this the impedance will change over time during which one or more voiding events happen and the liquid absorbent article contains more and more liquid acting as a varying capacitor dielectric. The measured impedance will vary in principle along the first impedance curve Z1 as shown in FIG. 3 versus time in that in a time span T1 prior to the first voiding event the impedance Z1 remains more or less constant, i.e. assuming an impedance value that remains within some predefined limits set for characterizing a constant behavior. After a first voiding event during T2 though, the impedance will change and, for example, drop to some first level Z11. After remaining more or less at a constant level again, a further voiding event during T4 will result in the impedance changing again, and, for example, assuming some further level Z12. As can be seen from the schematic view of FIG. 3, the difference in impedance between the first level Z11 and the second level Z12 is relatively little and may impose corresponding difficulties for reding out the sensor arrangement and assessing the measured readout, specifically in the context of identifying and/or counting individual voiding events.

As the embodiments of the present invention consider a plurality of planar capacitors and that at least two of said planar capacitors are connected in parallel, the readout will be different, although the capacitors are again arranged along the liquid absorbent layer as in the above-described scenario. More specifically, the capacitors are planar and with this also co-planar with the liquid absorbent layer, which is, however, also to include the fact that the “plane” of the sensor arrangement is flexible so as to assume a curved form generally following the outer surface of the absorbent article (see. schematic curvatures in FIGS. 1 and 2B).

As a consequence, the first voiding event will result in accumulation of liquid in a first zone or area. The capacitor facing this zone or area will accordingly change its capacity and affect the measured impedance. Namely, the impedance Z2 will assume the value Z21 in time T3 after the first voiding event after time T1 and during time T2. As the second voiding event during time T4 will result in accumulating liquid in a zone different from the first zone a further different capacitor will be affected. Assuming that this further capacitor is the one that is connected in parallel with the capacitor affected by the first voiding event the impedance Z2 of the parallel connection of both capacitors will reach the value Z22, with the additional characteristic that the “plateaus” Z21 and Z22 are substantially more distinct from each other than the plateaus Z11 and Z12 of the case of a single, but larger, capacitor. The embodiments of the present invention may thus provide the advantage that the individual voiding events can be identified much more reliably by exploiting a much more pronounced differentiating behavior of the measured impedance (Z2 vis-a-vis Z1).

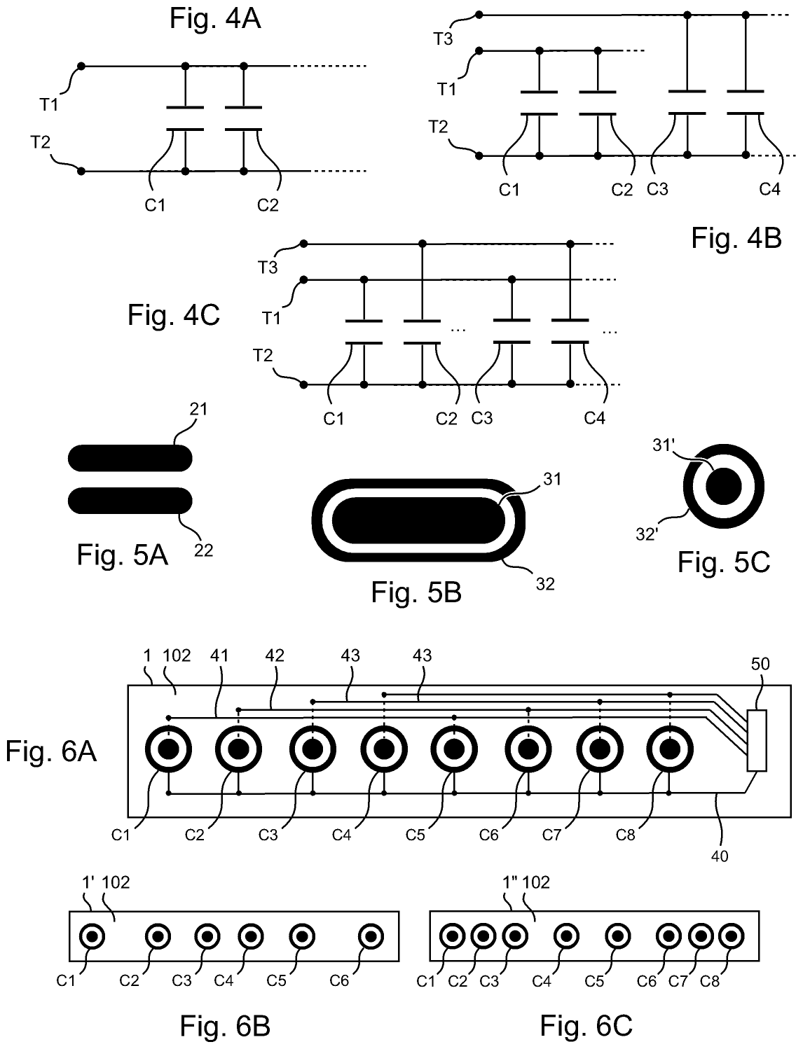

FIGS. 4A to 4C show schematic views of parallel connections of capacitors in a sensor arrangement according to corresponding embodiments of the present invention. Specifically, FIG. 4A in principle reflects the situation of at least two of the capacitors being connected in parallel as described with the second impedance Z2 in conjunction with FIG. 3. The impedance can be measured via connecting a network analyzer circuit to the terminals or connection points T1 and T2 of the two branches of the parallel connection of capacitors C1 and C2.

Further, FIG. 4B shows the schematic view of the parallel connection in which there are at least two pairs of parallel connected planar capacitors. Namely, there is provided a first pair of the parallel capacitors C1 and C2 and a second pair of the parallel capacitors C3 and C4. The first pair is accessible through terminals T1 and T2, whereas the second pair is accessible through terminals T1 and T3. In this embodiment, again a mainly longitudinal extension of the liquid absorbent layer and its related absorption sequence is assumed, so that voiding events would, for example, affect C1, then C1 and C2, then C1, C2, and C3 and so forth. By means of forming several pairs of individually parallel-connected capacitors the readout can be even more improved as, for example, the second pair C3/C4 is not at all affected by the first two voiding events.

Further, FIG. 4C shows the schematic view of a further parallel connection in which there are at least two pairs of parallel connected planar capacitors. Namely, the individual planar capacitors of pairs of parallel connected planar capacitors are arranged in an interlaced order. Namely, there is again provided a first pair of the parallel capacitors C1 and C3 and a second pair of the parallel capacitors C2 and C4. The first pair is accessible through terminals T1 and T2, whereas the second pair is accessible through terminals T1 and T3. However, capacitor C2 is arranged between the parallel-connected capacitors C1 and C3, and capacitor C3 is arranged between the parallel-connected capacitors C2 and C4. In other words, the individual planar capacitors of the pairs of parallel connected planar capacitors are arranged in an interlaced order so that the individual planar capacitors of one pair are not arranged next to each other. Specifically, such an arrangement can be employed such that the distance between the individual planar capacitors of one pair is maximized.

In this embodiment, again a mainly longitudinal extension of the liquid absorbent layer and its related absorption sequence is assumed, so that voiding events would, for example, affect C1, then C1 and C2, then C1, C2, and C3 and so forth. By means of forming several pairs of individually parallel-connected capacitors and the interlaced arrangement, the readout can be improved as, for example, the initial voiding events can be identified not only by separate capacitors but even by separate capacitors of separate pairs with a corresponding separate readout line. It can be a specific advantage to consider such an embodiment when there is a focus on identifying initial voiding events relative to later voiding events, or generally lying a focus onto a first group of capacitors over a second group of capacitors associated to a lesser significance and/or importance.

FIGS. 5A to 5C show schematic views of electrode layouts of capacitors in a sensor arrangement according to corresponding embodiments of the present invention. In principle, these embodiments all consider that the capacitor electrodes are coplanar, in the sense that the electrode areas follow the shape of the substrate allowing thus for bending and curvatures. In general, the 0-Volts or ground terminal of the network analyzing function is connected to the outer electrode and the signal is connected to the inner circle, or vice versa. Typical dimensions in term of diameters, widths or diagonal extension range from about 15 to 25 mm in transverse direction, from about 15 to 70, preferably 30 to 60 mm in longitudinal direction. It is preferred to have the oblong shape of electrodes as in FIG. 5B, mainly to achieve good coverage on the strip with small “dead areas” between adjacent electrode, while keeping the number of electrodes reasonable.

In some embodiments as shown in FIG. 5A, the capacitor electrodes assume a pad-like shapes 21, 22 and thus form a planar capacitor by means of simple and reliable shape forming with easy contacting that may avoid—at least to some extent—the crossing of conducting paths. FIGS. 5B and 5C show schematic views of electrode layouts in which the capacitor electrodes assume a concentric shape (FIG. 5B: pad-like shapes 31, 32, e.g. oval; FIG. 5C: circular shapes 31′, 32′). Such layouts may contribute to focusing the electric field distribution within the dielectric, i.e. within the liquid absorbent article. The response may thus be focused on liquid that is localized in a specific and predeterminable manner, as the trajectories of the majority of the electric field lines concentrate to a volume defined by the footprint of the outer one of the concentric electrodes, i.e. respectively electrodes 32, 32′.

FIGS. 6A to 6C show schematic views of electrode and capacitor configurations in strip-like sensor arrangements according to corresponding embodiments of the present invention. FIG. 6A focuses on further general aspects of a strip-like sensor arrangement 1, which includes—for example, circular and concentric electrode pads for a plurality of capacitors C1, C2, . . . C8. There are also shown a plurality of conductor paths 40, 41, . . . 44 on or in the substrate 1 connecting the capacitor electrodes toward terminals of a readout circuit. Specifically, there is shown an embodiment in which the sensor arrangement 1 also includes a connector 50 toward a readout circuit. The latter may be for example formed by a compact and sealed electronic device that can be exchangeable affixed and connected to the sensor arrangement 1 by a tight fit to the connector 50. The mentioned readout circuit may provide the suitable and applicable functionalities such as power supply, network analysis, data processing, communication, operation, etc.). Other but related embodiments of the present invention consider that the sensor arrangement include such a readout circuit, which may render it possible to dispense with the connector and to implement the readout circuit even on the same substrate on which the capacitor electrodes and/or the conductive paths are structured. In any way, the readout circuit may also include a transmitter part, wherein then only the transmitter part may be detachable.

In this embodiment the parallel connection of the planar capacitors C1, C2, . . . C8 is realized before the connector 50. Namely, all first electrodes of all planar capacitors C1, C2, . . . C8 are connected to a first common terminal line as implemented by a conductive path 40. The respective second electrodes of the parallel connected capacitors C1 and C5 are connected to a corresponding second common terminal line as implemented by a conductive path 41. A similar scheme applies to the further pairs of capacitors C2 & C6, C3 & C7, and C4 & C8. In this way the planar capacitors are connected in parallel by means of said plurality of conductor paths 40, 41, . . . 44 on the substrate 1. The conductor paths 40, 41, . . . 44 as well as the electrode pads of the capacitors C1, C2, . . . C8 may be implemented as conducting paths and areas of a flexible printed circuit board, including the usual multitude of layers and vias there in between.

In an application case, the present embodiment can be considered under the assumption that capacitor C4 in the middle is intended to represent the primary point of urination, with a relatively high probability that this is the capacitor that first will detect wetness. Following this, a subsequent detection of a change of impedance in the pair including capacitors C1 and C5, it can be assumed that capacitor C5 adjacent to the middle capacitor C4 detects liquid absorption and not capacitor C1 at the end remote from capacitor C5 (but connected in parallel), since none of C2, C3, C6, C7 and C8 was detected “wet”. Likewise, if after capacitor C4 it is the pair of capacitors C3 and C7 that experiences an impedance change, then it can be assumed that liquid absorption took place near C3 and not C7. In this way, also a direction of subsequent liquid absorption can be considered and/or determined.

FIG. 6B shows a schematic view of electrode and capacitor configurations in a strip-like sensor arrangement according to an embodiment of the present invention, which focuses on the mutual distance between adjacent capacitors. Specifically, the sensor arrangement 1′ includes a plurality of capacitors C1, C2, . . . wherein a mutual distance between two adjacent planar capacitors increases toward at least one end of the substrate 102. In the shown configuration, the distance between capacitors C1 and C2, and, respectively C5 and C6 is greater than the distance between capacitors C3 and C4. The capacitors C1, C2, C5 and C6 are located closer to an end of the strip-like sensor arrangement 1′ as compared to the somewhat “central” capacitors C3 and C4. This embodiment considers a certain location which may be assumed as the source of the bodily fluid. Specifically, if the strip-like sensor arrangement 1′ is to be attached to a diaper 9, as shown for example in FIG. 1, then the center of the strip may coincide with—or at least near to—the ureter outlet. This embodiment may thus be preferable when the initial voiding events are of particular interest and perhaps one or more subsequent voiding events may not need to be distinguished.

FIG. 6C shows a schematic view of electrode and capacitor configurations in a strip-like sensor arrangement according to an embodiment of the present invention, which again focuses on the mutual distance between adjacent capacitors. Specifically, the sensor arrangement 1″ includes a plurality of capacitors C1, C2, . . . wherein a mutual distance between two adjacent planar capacitors decreases toward at least one end of the substrate 102. In the shown configuration, the distance between capacitors C1 and C2, and, respectively C7 and C8 is smaller than the distance between capacitors C4 and C5. The capacitors C1, C2, C7 and C8 are located closer to an end of the strip-like sensor arrangement 1″ as compared to the somewhat “central” capacitors C4 and C5. This embodiment again considers a certain location which may be assumed as the source of the bodily fluid. However, this embodiment may be preferable when the initial voiding events are of lesser importance and it is the later voiding events that are of particular interest. Specifically, applications that consider the need and the corresponding point in time of a change of a full absorbent article may want to clearly distinguish between voiding events that happen toward a full capacity of the absorbent article.

Although detailed embodiments have been described, these only serve to provide a better understanding of the invention defined by the independent claims and are not to be seen as limiting.

1. A sensor arrangement for sensing a filling state of an absorbent article with a liquid absorbent layer, the sensor arrangement comprising:
a substrate,
a plurality of planar capacitors, each one comprising a set of at least two corresponding capacitor electrodes being arranged next to each other on or in the substrate, and
a plurality of conductor paths on or in the substrate connecting the capacitor electrodes toward terminals of a readout circuit,
wherein at least two of said planar capacitors are connected in parallel.

2. The sensor arrangement according to claim 1, wherein the substrate assumes an elongated strip-like shape with a longitudinal direction along the elongation, and wherein the planar capacitors are arranged along said longitudinal direction.

3. The sensor arrangement according to claim 2, wherein a mutual distance between two adjacent planar capacitors increases toward at least one end of the substrate.

4. The sensor arrangement according to claim 2, wherein a mutual distance between two adjacent planar capacitors decreases toward at least one end of the substrate.

5. The sensor arrangement according to claim 1, comprising at least two pairs of parallel connected planar capacitors.

6. The sensor arrangement according to claim 5, wherein the individual planar capacitors of said pairs of parallel connected planar capacitors are arranged in an interlaced order.

7. The sensor arrangement according to claim 1, further comprising a connector toward said readout circuit.

8. The sensor arrangement according to claim 7, wherein the parallel connection of said planar capacitors is realized before said connector.

9. The sensor arrangement according to claim 8, wherein the planar capacitors are connected in parallel by means of said plurality of conductor paths on the substrate.

10. The sensor arrangement according to claim 1, wherein the capacitor electrodes assume a pad-like shape.

11. The sensor arrangement according to claim 1, wherein the capacitor electrodes assume a concentric shape.

12. The sensor arrangement according to claim 1, wherein the substrate comprises a first and second surface, wherein the capacitor electrodes are arranged on together on one of said first and second surface.

13. The sensor arrangement according to claim 12, wherein the capacitor electrodes are coplanar.

14. The sensor arrangement according to claim 1, wherein the substrate is flexible.

15. The sensor arrangement according to claim 1, arranged to accompany the liquid absorbent layer of the absorbent article.

16. The sensor arrangement according to claim 1, further comprising said readout circuit.

17. An absorbent article comprising a sensor arrangement according to claim 1.
